(19) United States
(12) Patent Application Publication
(10) Pub. No.: US 2024/0241499 A1
(43) Pub. Date: Jul. 18, 2024

(54) METHOD FOR MONITORING MACHINING PROCESSES IN A PROCESSING MACHINE, AND PROCESSING MACHINE

(71) Applicant: TRUMPF Werkzeugmaschinen SE + Co. KG, Ditzingen (DE)

(72) Inventors: Gerhard Hammann, Korntal-Münchingen (DE); Rainer Hank, Eberdingen (DE); Stephan Niessner, Illertissen (DE)

(21) Appl. No.: 18/617,786

(22) Filed: Mar. 27, 2024

Related U.S. Application Data
(63) Continuation of application No. PCT/EP2022/074844, filed on Sep. 7, 2022.

(30) Foreign Application Priority Data
Sep. 30, 2021 (DE) 10 2021 125 418.3

(51) Int. Cl. G05B 19/4065

(52) U.S. Cl. CPC G05B 19/4065; G05B 2219/37252

(57) ABSTRACT

A method for monitoring machining processes in a processing machine which machines workpieces using a machining tool that includes an upper tool and a lower tool. Time-synchronous process signals are registered during each machining process by sensors of the processing machine and transmitted to a control device. The process signals determined as a function of time during the machining processes are converted by a transformation into characteristic curves having a force-distance profile, and recorded independently of time in a force-distance diagram. Wear of the machining tool is determined separately from one another and/or the material of the workpiece, which underlies the at least one machining process, from the profile of the characteristic curves in the force-distance diagram.

### CROSS-REFERENCE TO RELATED APPLICATION

This application is a continuation, under 35 U.S.C. § 120, of copending International Patent Application PCT/EP2022/074844, filed Sep. 7, 2022, which designated the United States; this application also claims the priority, under 35 U.S.C. § 119, of German Patent Application DE 10 2021 125 418.3, filed Sep. 30, 2021; the prior applications are herewith incorporated by reference in their entirety.

### FIELD AND BACKGROUND OF THE INVENTION

The invention relates to a method for monitoring machining processes in a processing machine and a processing machine for carrying out machining processes, in which in particular plate-shaped workpieces are machined using a machining tool.

A method for monitoring a tool clamping device installed in a work spindle is known from German published patent application DE 10 2019 123 838 A1. A clamping force of the work spindle installed in the tool clamping device is generated by a spring assembly, which exerts a force in the direction of the clamping position on an actuating element causing the clamping or release of a tool or toolholder. Upon release and/or upon clamping of a tool or a toolholder, the spring force and the travel of the actuating element are continuously measured and each recorded as a function of time. At least one characteristic parameter for the status of the tool clamping device is determined from these recorded functions. A spring characteristic curve in the form of the spring force as a function of the travel can be determined from the spring force and the travel as a function of time, the evaluation of which can give information about an array of characteristic parameters.

A monitoring system for tool wear is known from Korean published patent application KR 2005 0115153 A, in order to increase the effectiveness in the machining, in particular in the case of automation. Wear of the tool is registered in relation to the cutting force. Due to the increasing wear, an increasing cutting force is required, as is shown from a linearly rising characteristic curve, registered from the measured values, in a force-distance diagram.

United States published patent application US 2020/0089191 A1 discloses a method for monitoring tool wear in a machine tool. That method initially comprises the step of defining the tolerance range of the wear in the tool. Data of the cutting tool from typical machining ranges are then registered, for example, by registering a cutting force as a function of time. Coefficients of the characteristic curves are then determined from the values of the machining ranges and compared to currently registered data in order to determine the wear as a function of the tolerance range.

### SUMMARY OF THE INVENTION

It is accordingly an object of the invention to provide a method and a processing machine which overcomes a variety of the heretofore-known devices and methods of this general type and which provides for a method for monitoring machining processes in a processing machine and a processing machine so that a uniform quality is enabled during the machining of workpieces.

With the above and other objects in view there is provided, in accordance with the invention, a method for monitoring machining processes in a processing machine, the method comprising:
in the machining processes, machining a workpiece with a machining tool that includes an upper tool and a lower tool;
during each machining process, registering time-synchronous process signals by sensors of the processing machine and transmitting the time-synchronous process signals to a control device;
converting the process signals determined as a function of time during the machining processes by a transformation into characteristic curves having a force-distance profile, and recording the force-distance profile independently of time in a force-distance diagram; and
from a profile of the characteristic curves in the force-distance diagram, determining separately from one another at least one of a wear of the machining tool or a material of the workpiece underlying a respective machining process.

In other words, the above and other objects are achieved by a method for monitoring machining processes in a processing machine, in which a, particularly plate-shaped, workpiece is machined by the machining processes using a machining tool. The machining tool comprises an upper and lower tool. During the respective machining process time-synchronous process signals are registered by sensors of the processing machine in a control device, in which the process signals determined as a function of time during the machining process are converted by a transformation into characteristic curves having a force-distance profile, which are recorded independently of time in a force-distance diagram, and in which the wear of the machining tool and/or the material of the plate-shaped workpiece is determined from the profile of the characteristic curves in the force-distance diagram. Due to the registration of a large number of process signals during the respective machining process from the machining tool and the workpiece by sensors of the processing machine, by way of the evaluation strategy by means of a transformation of the determined process signals into characteristic curves, which are recorded independently of time in a force-distance diagram, a change of the process signals within the machining processes can be evaluated, in particular with respect to the wear of the machining tool and/or the material of the workpiece being machined. As a result, an evaluation about the quality of the machining of the workpiece, in particular a cut surface quality, can also be derived therefrom.

The above-mentioned control device can be provided in the processing machine and outside the processing machine. The control device is also understood to mean that signals and/or registered values are exchanged with a cloud network or the evaluation takes place in the cloud network or similar networks.

It is preferably provided that before the transformation of the process signals, signal variances of the determined process signals from multiple successive machining processes are eliminated. Due to this elimination of the signal variances, an exact evaluation of the force-distance profile with respect to the wear and/or the determination of the material of the machined workpiece can take place and as a result a performed cut surface quality on the workpiece can also be determined therefrom.

It is advantageously provided that to eliminate the signal variances, additional travel components of the upper tool and/or lower tool during the machining process, in particular during a stroke movement of the machining tool, are registered by one or more sensors which determine signals identical signals identical to or different from one another, in particular by at least one travel sensor and/or at least one acceleration sensor.

Furthermore, to eliminate signal variances, elastic travel components of a machine frame of the processing machine can preferably be registered by sensors, for example, by distance and/or acceleration sensors. These elastic travel components from the machining tool and the machine frame result in extended travel distances in the stroke movement of the machining tool in the processing machine, which result from elastic deformations in the force-subjected machine frame or from force-subjected machine parts and the machining tools with a rising process force.

Furthermore, it is preferably provided that to eliminate the signal variances, a deviation of the travel components of the upper tool and/or lower tool as a result of successive work cycles during repeating machining processes are registered. In particular as a result of waiting times between two work cycles or machining processes and different accelerations or velocities in the movement of the upper tool and/or lower tool during repeating processes, such chronological drifts or deviations can take place in the stroke movement of the machining tools, which would corrupt an evaluation of the process signals.

The additionally determined travel components are thereupon evaluated by a regression function and an initial travel of the upper tool and/or lower tool is determined. This initial travel is determined from a position shift of the upper tool and/or lower tool as a result of an increasing process force of the machining tool and a subsequent subtraction or addition of the measured travel of the stroke movement of the tools. The tool dynamics and the dynamics of the processing machine can thus be quasi-frozen, so that the signal variances in process signals resulting from such dynamics of the processing machine and the tool can be eliminated.

Furthermore, it is preferably provided that the process signals eliminated of the signal variances are converted by the transformation independently of time into characteristic curves with a force-distance profile in the force-distance diagram, wherein the initial travel of the machining tool in relation to the workpiece to be machined is used as the basis. Alternatively, the elastic travel components of the machine frame can be depicted by an analytical model of the machine and tool components.

It is preferably provided that during the machining processes, a stroke force is registered by at least one sensor, in particular force sensor, of the processing machine and a stroke movement of the upper tool and/or lower tool is registered by at least one sensor, in particular a distance sensor, and the travel components of the machine frame and the machining tool as a function of time for the respective machining process are registered by at least one acceleration sensor, and characteristic curves having the force-distance profile in the force-distance diagram for the determination of the tool wear are recorded from the process signals eliminated of the signal variances by transformation. The exact evaluation of the force-distance profile and thus with respect to the wear can be enabled by the consideration and query of these parameters.

In particular, it is provided that wear states of the machining tool are determined from the comparison of a reference force-distance profile with the machining tool without wear and the at least one force-distance profile determined by the determined machining process. The increasing wear of the machining tool can thus be monitored at any time during the machining processes and a statement can also be achieved about the quality of the workpiece produced.

For the upper and lower tool, a classification for the wear states is preferably defined jointly or separately and the registered wear states are compared to the classification stored in the control device. Continuous monitoring of the increasing wear during the machining is thus provided, which can also be recorded for the quality control. A signal for a tool change is advantageously output by the control device if the registered wear of the upper tool and/or lower tool is outside a specified classification, in the case in which the minimum requirements for the machining quality are still met.

Furthermore, it is preferably provided that an acoustic signal for the respective machining process is registered during the machining process by at least one sound sensor and is converted by a Fourier transform into a frequency range and thereupon a comparison to reference values is carried out on the basis of the amplitudes in the frequency ranges. The reference values are also based on amplitudes in the frequency range. This comparison is used to verify a statement from the characteristic curves from a force-distance profile. During the machining of the workpiece, in particular in punching machining, characteristic acoustic signals are each generated for different materials of the machined workpiece. These determined characteristic curves with the force-distance profile from the registered process signals of the machining processes are preferably in turn compared to a reference force-distance profile which is stored in the control device in order to thereupon be able to make the statement about which material the current machining involves. This is important in particular for monitoring the machining processes during automated production in order to ensure that the appropriate material of the workpiece is also provided in preparation for the automated production.

Furthermore, it is preferably provided that for a machining tool which is used for a severing process, in which a workpiece part is cut out from the workpiece, in particular a plate-shaped workpiece, a cut surface quality is monitored, which is determined from a direct correlation with the wear of the machining tool. With increasing wear of such a machining tool for a severing process, for example, for a punch or a punching die, a change occurs in the cut surface profile in the workpiece or workpiece part. The cut surface quality can thus be assessed depending on the tool wear.

The underlying object of the invention is furthermore achieved by a processing machine which is provided for machining workpieces, in particular plate-shaped workpieces. This processing machine comprises a machining tool having an upper tool, which is movable along a stroke axis using a stroke drive device in the direction of a workpiece to be machined using the upper tool and in the opposite direction, and can preferably be positioned along an upper positioning axis extending perpendicular to the stroke axis and has a motorized drive arrangement, by which the upper tool is movable along the upper positioning axis. The machining tool comprises a lower tool, which is aligned with the upper tool and is preferably movable along a lower stroke axis using a stroke drive device in the direction of the upper tool and in the opposite direction and can be positioned along a lower positioning axis, which is aligned perpendicularly to the stroke axis of the upper tool, and in particular is movable using a motorized drive arrangement along the lower positioning axis. The motorized drive arrangements for moving the upper and lower tool are activatable by a control device, which is connected to the processing machine. Via the control device, the processing machine according to one of the above embodiments is activatable for monitoring the machining processes for machining the workpiece. Such processing machines are preferably usable for autonomous production. The quality of the workpiece to be produced can be monitorable throughout autonomous production by the status registration of the processing machine.

Other features which are considered as characteristic for the invention are set forth in the appended claims.

Although the invention is illustrated and described herein as embodied in a method for monitoring machining processes in a processing machine and processing machines, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 shows a perspective view of a processing machine;

FIG. 2 shows a perspective view of an alternative processing machine to FIG. 1;

FIG. 3 shows a schematic side view of an upper tool and lower tool of a machining tool;

FIG. 4 shows a schematic side view of an upper tool and lower tool of a machining tool of an alternative machining tool to FIG. 3;

FIG. 5 shows a diagram having time-synchronous process signals registered by the processing machine;

FIG. 6 shows a distance-time diagram of a severing process in a workpiece using the processing machine;

FIG. 7 shows a force-time diagram of the workpiece machined by the severing process according to FIG. 6;

FIG. 8 shows a distance-time diagram of an upper tool of the machining tool with an elastic machine component of the processing machine;

FIG. 9 shows a distance-time diagram of a die travel of the upper tool without elastic machine component of the processing machine;

FIG. 10 shows a force-distance profile of process signals according to FIG. 9 in a force-distance diagram;

FIG. 11 shows a force-distance diagram with multiple characteristic curves for the wear detection of the machining tool;

FIG. 12 shows a schematic enlarged sectional view of a cutting edge of the upper tool and the lower tool without wear and with wear according to FIG. 3;

FIG. 13 shows a schematic sectional view of a punch machining process using an upper tool and lower tool without wear; and

FIG. 14 shows a schematic sectional view of a punch machining process using an upper tool and a lower tool with wear.

### DETAILED DESCRIPTION OF THE INVENTION

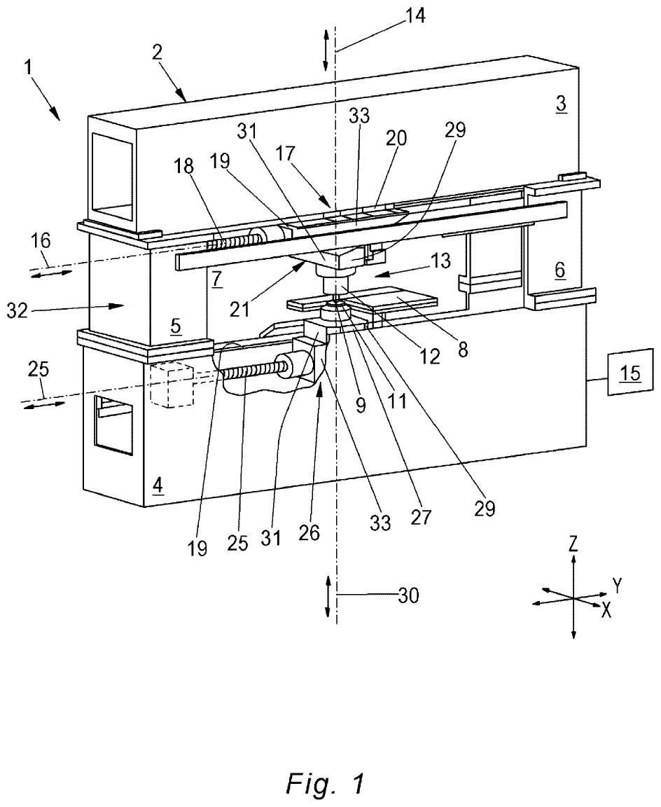

Referring now to the figures of the drawing in detail and first, in particular, to FIG. 1 thereof, there is shown a processing machine 1, which is designed, for example, as a punch press. The processing machine 1 comprises a load-bearing structure with a closed machine frame 2. The machine frame 2 comprises two horizontal frame legs 3, 4 and two vertical frame legs 5 and 6. The machine frame 2 encloses a frame interior 7, which forms the working region of the processing machine 1 with an upper tool 11 and a lower tool 9.

The processing machine 1 is used to machine plate-shaped workpieces 10, which for the sake of simplicity are not illustrated in FIG. 1, and which for machining purposes can be arranged in the frame interior 7. A workpiece 10 for machining is placed onto a workpiece support 8 which is provided in the frame interior 7. The lower tool 9, for example in the form of a punching die, is mounted, in an opening of the workpiece support 8, on the lower horizontal frame leg 4 of the machine frame 2. This punching die may be provided with a die opening. In the case of a punching machining operation, the upper tool 11 in the form of a punch dips into the die opening of the lower tool in the form of a punching die.

A machining tool of the processing machine 1 comprises an upper tool 11 and a lower tool 9. Instead of a punch and a punching die, the upper tool 11 and lower tool 9 may also be used as a bending ram and a bending die for shaping workpieces 10.

The upper tool 11 is fixed in a tool receptacle at a lower end of a plunger 12. The plunger 12 is part of a stroke drive device 13, by means of which the upper tool 11 can be moved in a stroke direction along a stroke axis 14. The stroke axis 14 extends in the direction of the Z axis of the coordinate system of a control device 15, indicated in FIG. 1, of the machine tool 1. Perpendicularly to the stroke axis 14, the stroke drive device 13 can be moved along a positioning axis 16 in the direction of the double arrow. The positioning axis 16 extends in the direction of the Y axis of the coordinate system of the control device 15. The stroke drive device 13, which receives the upper tool 11, is moved along the positioning axis 16 by means of a motor drive 17.

The movement of the plunger 12 along the stroke axis 14 and the positioning of the stroke drive device 13 along the positioning axis 16 are effected by means of a motor drive 17 in the form of a drive arrangement 17, in particular a spindle drive arrangement, with a drive spindle 18 which runs in the direction of the positioning axis 16 and which is fixedly connected to the machine frame 2. During movements along the positioning axis 16, the stroke drive device 13 is guided on three guide rails 19 of the upper frame leg 3, of which two guide rails 19 can be seen in FIG. 1. The one remaining guide rail 19 runs parallel to the visible guide rail 19 and is spaced apart from the latter in the direction of the X axis of the coordinate system of the digital controller 15. Guide shoes 20 of the stroke drive device 13 run on the guide rails 19. The mutual engagement of the guide rail 19 and of the guide shoes 20 is such that this connection between the guide rails 19 and the guide shoes 20 can also accommodate a load acting in a vertical direction. The stroke device 13 is accordingly suspended on the machine frame 2 by means of the guide shoes 20 and the guide rails 19. A further part of the stroke drive device 13 is, for example, a wedge mechanism 21 by which a position of the upper tool 11 relative to the lower tool 9 is settable.

The lower tool 9 is received so as to be movable along a lower positioning axis 25. This lower positioning axis 25 extends in the direction of the Y axis of the coordinate system of the digital controller 15. The lower positioning axis 25 is preferably oriented parallel to the upper positioning axis 16. The lower tool 9 can, directly at the lower positioning axis 16, be moved along the positioning axis 25 by means of a motorized drive arrangement 26. Alternatively or additionally, the lower tool 9 can also be provided on a stroke drive device 27, which can be moved along the lower positioning axis 25 by means of the motorized drive arrangement 26. This drive arrangement 26 is preferably in the form of a spindle drive arrangement. The lower stroke drive device 27 may correspond in terms of design to the upper stroke drive device 13. The motorized drive arrangement 26 may likewise correspond to the motorized drive arrangement 17.

The lower stroke drive device 27 is likewise mounted displaceably on guide rails 19 which are assigned to a lower horizontal frame leg 4. Guide shoes 20 of the stroke drive device 27 run on the guide rails 19 such that the connection between the guide rails 19 and guide shoes 20 on the lower tool 9 can also accommodate a load acting in a vertical direction. Accordingly, the stroke drive device 27 is also suspended on the machine frame 2 by means of the guide shoes 20 and the guide rails 19 and so as to be spaced apart from the guide rails 19 and guide shoes 20 of the upper stroke drive device 13. The stroke drive device 27 may also comprise a wedge mechanism 21 by means of which the position or height of the lower tool 9 along the Z axis is settable.

The upper and/or lower drive device 13, 27 can alternatively also be formed by means of further drive components or drive concepts. For example, an electrically controlled drive mechanism or mechanical drive concepts can be provided. Pneumatic or hydraulic drive concepts can also be used.

By way of the control device 15, it is possible for both the motor drives 17 for a travel movement of the upper tool 11 along the upper positioning axis 16 and the motor drive or drives 26 for a travel movement of the lower tool 9 along the lower positioning axis 25 to be controlled independently of one another. The upper tool and lower tool 11, 9 are thus movable synchronously in the direction of the Y axis of the coordinate system. Equally, it is possible for an independent movement of the upper tool and lower tool 11, 9 to also be controlled in different directions. This independent movement of the upper tool and lower tool 11, 9 may be controlled simultaneously. The decoupling of the movement between the upper tool 11 and the lower tool 9 makes it possible to obtain increased flexibility in the processing of workpieces 10. The upper tool and lower tool 11, 9 can also be configured in a variety of ways for processing of the workpieces 10.

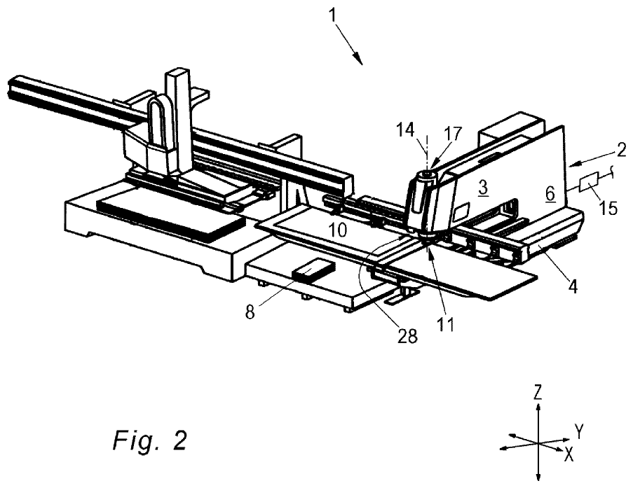

FIG. 2 shows a perspective view of an alternative embodiment of the processing machine 1 according to FIG. 1. This processing machine 1 differs, for example, in the structure of the machine frame 2. In this processing machine 1, the machine frame 2 is made C-shaped, i.e., a vertical machine frame 5 is provided between the upper horizontal frame leg 3 and the lower horizontal frame leg 4. An upper tool 11 is provided, for example, at the open end of the upper horizontal machine leg 3. The lower tool 9 is provided opposite at the open end of the lower horizontal frame leg 4 and adjacent to the upper tool 11. Additionally or alternatively to the upper tool 11, a cutting processing head 28, for example, for laser cutting or plasma cutting, can be provided at the upper horizontal frame leg 3. Alternatively and/or additionally to the upper tool and lower tool 11, 9, a bending tool can also be provided.

The processing machine 1 of the displaceable embodiments is equipped with multiple sensors. Various signals can be registered by these sensors during the machining of the workpiece 10 using the processing machine 1. The sensors are preferably oriented in a direction of action in which the signals are to be registered. For example, a sensor can be designed as a strain gauge in order to register a bending strain of the machine frame 2 or, for example, a widening of the C-shaped machine frame at the vertical frame leg 6. The sensors can also register signals of a drive power, such as current and/or voltage, which arise during a travel movement and/or a stroke movement of the upper tool and/or lower tool 11, 9. The sensors can also register pressure profiles in pressure chambers which are generated during a work stroke in the hydraulic drive. The sensors can also register various sound levels in order to determine and monitor data therefrom in turn. The selection and the use of the respective sensor is dependent on the process signals to be determined, which are to be determined and evaluated for monitoring machining processes in the processing machine. For example, at least one distance measuring sensor 29 is provided on or in the upper tool 11 and/or lower tool 9 in order to register a stroke movement of the upper tool 11 and/or lower tool 9. Furthermore, at least one force sensor 31 can be provided on the upper tool 11 and/or on the lower tool 9 in order to register a force acting on a workpiece 10. Furthermore, at least one sound sensor 32 can be provided on the machine frame 2. In addition, one or more acceleration sensors 33 can be provided on the machine frame 2, on the upper tool 11, and/or on the lower tool 9. If a C-shaped machine frame 2 is provided, at least one acceleration sensor 33 is preferably positioned in each case in the area of the free end of the upper and lower horizontal frame leg 3, 4.

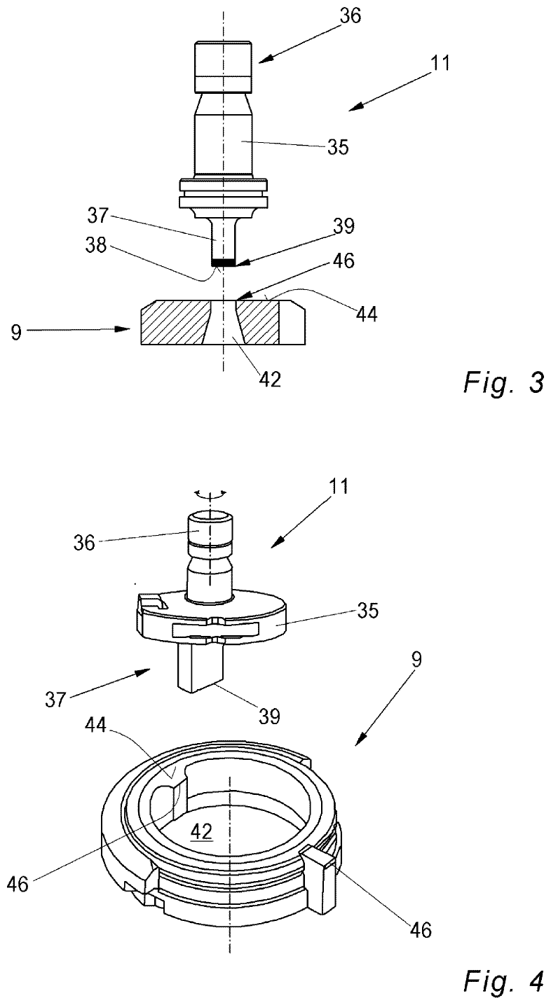

FIG. 3 shows the upper tool 11 in a schematic side view and the lower tool 9 in a schematic sectional view. In the exemplary embodiment, it is a cutting tool or punching tool. The upper tool 11 comprises a main body 35 having a chucking pin 36. A cutting tool 37 having a punching or stamping surface 38, which is circumferentially delimited by a cutting edge 39, is formed on the main body 35. The lower tool 9 is formed as a die, in particular as a perforated die. A through hole 42 is provided in a main body 41 of the lower tool 9. In the transition area from the through hole 42 to a support surface 44 for the workpiece 10, a cutting edge 46 is provided, which is adjoined by a cut surface 47, which merges into the through hole 42 enlarged in circumference.

FIG. 4 shows an alternative embodiment of the upper tool 11 and the lower tool 9 in relation to the embodiment according to FIG. 3. In this embodiment, the length of the cutting edge 46 on the lower tool 9 differs from the length and/or design of the cutting edge 39 of the upper tool 11. It can also be seen from this embodiment that, for example, a cutting edge 46 can be provided inside a through hole 42 on the die 9 and also outside the through hole 42. The upper tool 11 can also comprise a square stamping or punching surface or a round punching surface or further free shapes instead of a rectangular stamping surface 38.

The cutting edge 39 in the upper tool 11 and the cutting edge 46 on the lower tool 9 are each subject to wear. The wear of the upper tool and lower tool 11, 9 has a disadvantageous effect on the cutting quality on the workpiece 10 or the machining quality. To achieve a uniform machining quality during a large number of successive machining processes 49 (see FIG. 3), in particular in autonomous production, monitoring of the machining processes 49, which is described in more detail hereinafter, is carried out. At the same time, the monitoring of the machining processes 49 enables an active adaptation of parameters of the machining processes 49 by the control device 15 from the determined information, so that automated improvements during the automated production are also enabled.

The method for monitoring described hereinafter enables the determination of wear of the upper tool and lower tool 11, 9. It can also be queried and determined which material of the workpiece 10, in particular the plate-shaped workpiece, underlies the machining. In addition, a statement can also be made about a cut surface quality of the workpiece part 8, which was cut out from the workpiece 10, if the workpiece part 8 is provided for further processing and the sheet skeleton thus resulting from the workpiece 10 serves as waste. A statement can also be made about a cut surface quality of the workpiece 10, from which one or more workpiece parts 8 are cut out or severed as waste. The machining of the workpiece 10 can comprise cutting out, perforating, cutting off, notching, or the like.

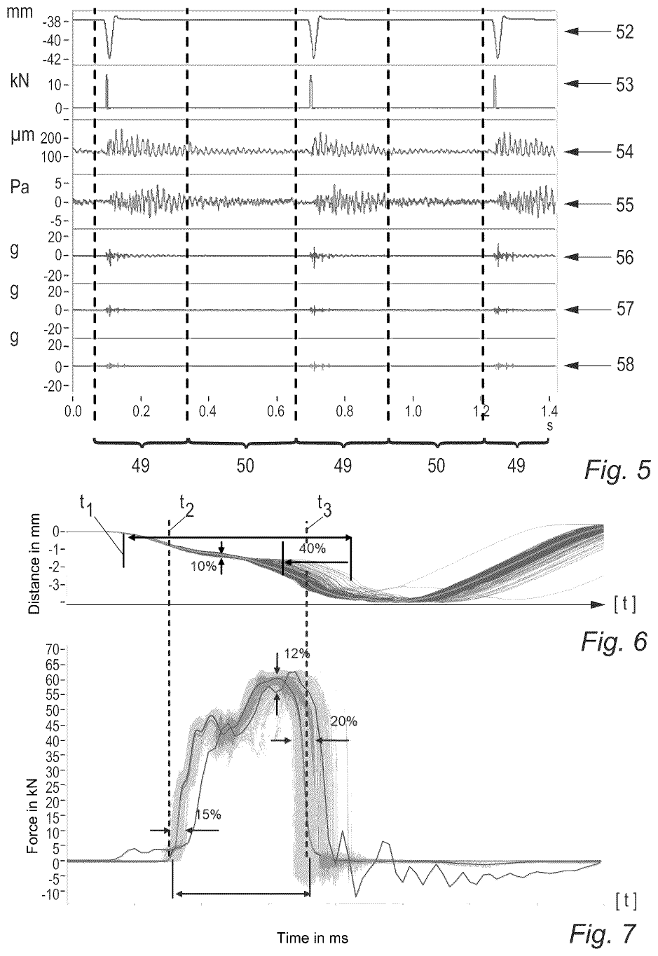

FIG. 5 shows a schematic diagram in which time-synchronous process signals for, for example, three successive machining processes 49 are shown. This machining process 49 relates, for example, to punching machining of the workpiece 10 by means of a punching tool according to FIG. 3. A waiting time or an idle time 50 for the upper tool and lower tool 11, 9 is provided between the machining process 49, until, for example, the plate-shaped workpiece 10 is transferred into a new machining position and/or the upper tool 11 and the lower tool 9 are transferred into a corresponding machining position, before the following stroke of the upper tool 11 and/or lower tool 9 is activated. Multiple process signals are shown synchronized in time in the diagram, which are each registered by sensors. A process signal 52 can register, for example, a stroke movement of the upper tool 11 by means of the distance sensor 29. This applies in particular if only the upper tool 11 is activated with a stroke movement. A process signal 53 shows the force determined by the force sensor 31, for example, during the severing process. A process signal 54 is recorded, for example, by means of an acceleration sensor 33 and shows a travel component upon widening of the machine frame 2 during the machining process 49. A process signal 55 is determined by the sound sensor 32. The process signals 56 and/or 57 and/or 58 are each registered by acceleration sensors 33. The acceleration sensors 33 can register travel components in the X, Y, and/or Z direction of the machine frame 2. It is apparent that the individual sensors for registering the process signals 52 to 58 are only named as examples and data or information can also be calculated and determined by other sensors from their determined process signals.

FIG. 6 shows, for example, a distance-time diagram of the upper tool 11 made up of a large number of superimposed characteristic curves of the machining processes 49. At the point in time t1, the approach movement of the upper tool 11 towards the workpiece 10 begins. At the point in time t2, the upper tool 11 strikes the workpiece 10. At the point in time t3, the severing process is ended. It is apparent therefrom that a signal variance of, for example, 10% can already result at the beginning of the severing process. There can be a signal variance of, for example, 40% in the area of the severing around the point in time t3. The signal variances arise due to interfering influences, so that changes result therefrom during the machining of the workpiece, which disadvantageously influence the quality of the machining. These signal variances have an effect on the evaluation of the process signals and are eliminated as described hereinafter.

FIG. 7 shows characteristic curves in a force-time diagram during the stroke movement and punching machining of the upper tool 11 in relation to the workpiece 10 at the same time as the stroke movement according to FIG. 4 of multiple machining processes 49. The beginning of the severing process can be recognized from the force increase at the point in time t2. A signal variance in the force to be applied of, for example, 15% is already provided at this point in time, i.e., the placement point in time of the upper tool 11 on the workpiece 12 is not identical in multiple successive machining steps in the time series. Signal variances can be illustrated in these time series which are not present in real observations. This applies analogously to the point in time t3, at which the severing of the workpiece 10 takes place.

The signal variances shown in FIGS. 6 and 7 during a large number of successive machining processes 49 are a result, on the one hand, of additional travel components of the upper tool and lower tool 11, 9 and elastic travel components of the machine frame 2 resulting in longer stroke distances in the stroke movement of the upper tool and/or lower tool 11, 9, in particular as a result of the elastic deformation of the force-subjected upper tool and/or lower tool 11, 9 and machine frame 12. In addition, a time drift or a deviation in the stroke movement of the upper tool and/or lower tool 11, 9 is provided as a result of the waiting times 50 between the machining processes 59. This time deviation is a result, for example, of the changing response behaviour of electric motors, the fill level of hydraulic buffer storage devices, or the like, which can be provided in the processing machine 1.

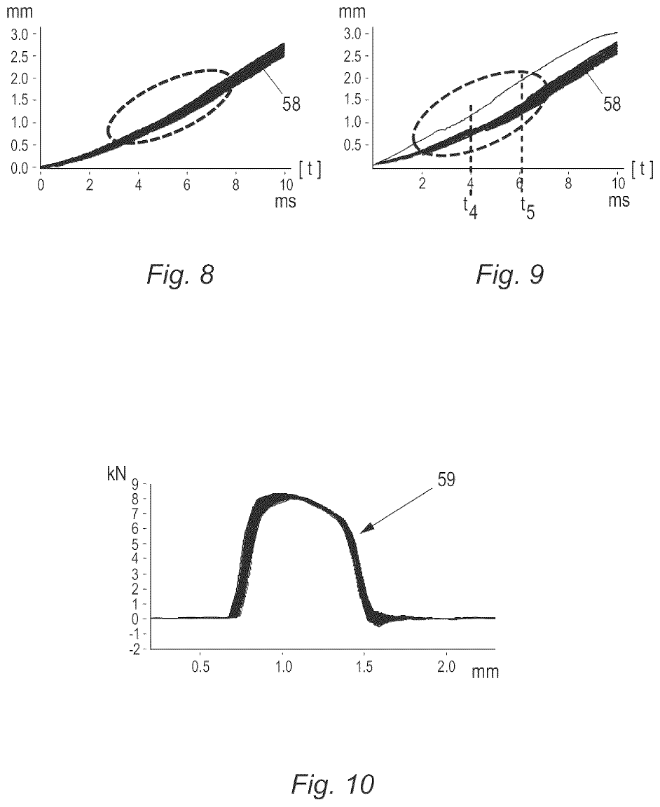

FIG. 8 shows, for example, a stroke movement of the upper tool 11 with elastic travel components of the machine frame 2. The Y axis shows the elastic travel component of the machine frame 2, which is plotted over time along the X axis. The characteristic curves 58 show the registered travel components, for example by a distance measurement, which can be registered by sensors.

FIG. 9 shows an analogous diagram to FIG. 8, wherein the registered elastic travel components, which are registered, for example, by acceleration sensors 33, were eliminated in the machine frame 2. For example, a first inflection in the characteristic curves 58 at the point in time t4 depicts the striking of the upper tool 11 on the workpiece 10, the following inflection in the characteristic curves 58 at the point in time t5 shows the passage of the upper tool 11 through the workpiece 10. The elastic components of the machine frame 2 can be directly measured from the values of the characteristic curves 58 or determined as a regression function by an analytical model of the elastic components. The characteristic curves 58 can be eliminated of this signal variance by the addition or subtraction of the travel components of the machine frame 2. This step can also be referred to as freezing the tool dynamics and the machine dynamics or eliminating the tool dynamics and the machine dynamics. This applies analogously, for example, for the process signal 53, which shows the cutting force profile during the machining processes 49.

Proceeding therefrom, the time dependence of the process signals 55 to 58 is eliminated by a transformation of the characteristic curves 58 of the distance-time diagram into a force-distance diagram. FIG. 10 shows such a force-distance profile of characteristic curves 59 obtained by the transformation. Due to the independence from time with respect to the time-synchronous process signals 55 to 58 according to FIG. 4, the profile of the characteristic curves 59 is better comparable for the individual machining processes, in particular bending processes or severing processes. The scattering of the characteristic curve 59 can thus be reduced, since the same work, thus force per distance, is required with constant workpiece and tool conditions for each covered distance.

Due to the elimination of the time dependence, an exact evaluation of the force-distance profile of the upper tool and/or lower tool 11, 9 with regard to wear and thus preferably also for a finished cut surface quality is enabled.

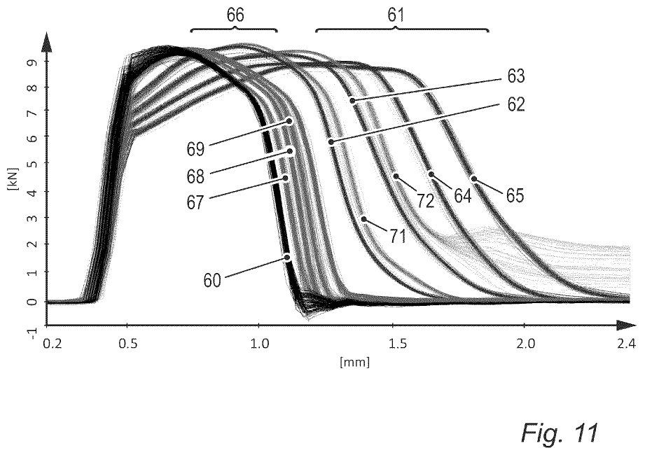

FIG. 11 shows, for example, a force-distance diagram in which multiple force-distance profiles of characteristic curves are assigned to one another. The travel, in particular the punch travel, is plotted along the X axis and the cutting force is plotted along the Y axis. This diagram according to FIG. 11 is used to illustrate registered wear of the upper tool 11 and/or lower tool 9 and/or of the machining tool in relation to an upper tool and/or lower tool 11, 9 and/or machining tool without wear.

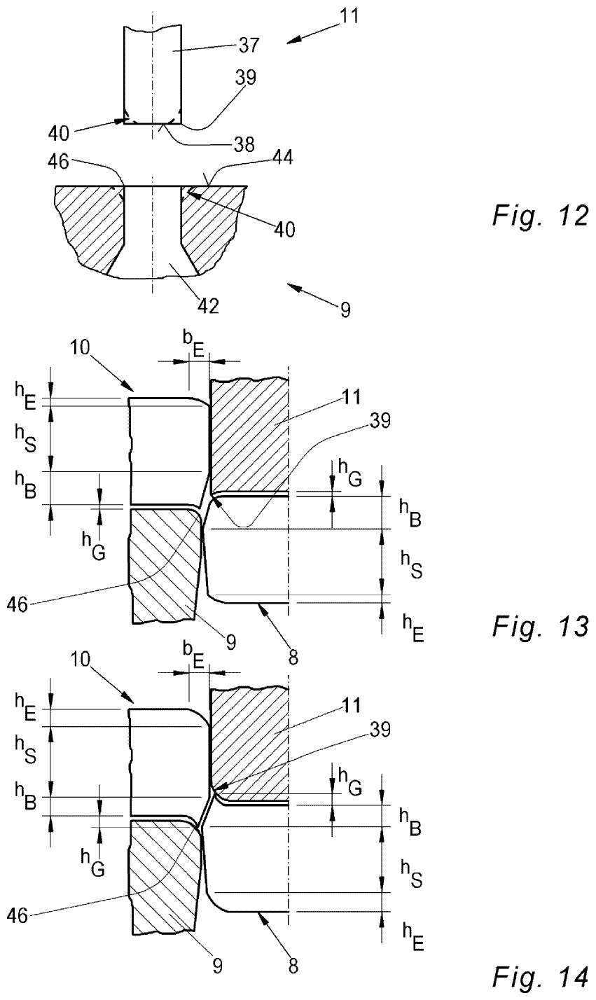

FIG. 12 schematically shows in enlarged form the cutting edge 39 of the upper tool 11 and the cutting edge 46 of the lower tool 9. In the case of a still unused upper tool 11 and lower tool 9, the cutting edges 39, 46 are formed at right angles, for example, in particular sharp edged, as shown by the solid lines. These cutting edges 39, 46 wear in the course of use. These cutting edges 39, 46 become rounded in this case, as shown by the dashed line 40. The cutting edge 39 in the upper tool 11 wears significantly more severely and faster here than the cutting edge 46 in the lower tool 9.

FIG. 13 shows a schematic enlarged sectional view of the upper tool and lower tool 11, 9 during a machining process, in which a workpiece part 8 is cut out from a workpiece 10 by punching machining of the upper tool and lower tool 11, 9. The cutting edge 39 of the upper tool 11 and the cutting edge 46 of the lower tool 9 are without wear. The following cut surface parameters result here on the workpiece 10 or workpiece part 8: A rollover height h_{E} is low. The width of the rollover b_{E} is also low and slightly rounded. A clean cut height h_{S} extends thereafter, and a fracture zone height h_{B} results adjoining thereon. Only a low cutting burr height h_{G} results at the lower end of the workpiece 10 or workpiece part 8. The ratios in the workpiece part 8 along the cut surface and those in the workpiece 10 are provided quasi-analogously—but only in mirror image.

FIG. 14 shows a schematic sectional view analogous to FIG. 13. Differing therefrom, the cutting edge 39 of the upper tool 11 and the cutting edge 46 of the lower tool 9 each have wear 40, as shown by the dashed line 40 in FIG. 12, for example. The following change results therefrom for the cut surface parameters: The rollover width b_{E} and the rollover height h_{E} increase significantly. The clean cut height h_{S} increases and the fracture zone height h_{B} decreases. However, the height of the cutting burr h_{G} rises due to the increasing wear at the cutting edge 46 of the lower tool 9. In particular, a significant burr thus forms on the workpiece part 8. With such a cutting result, a replacement of the upper tool and/or lower tool 11, 9 becomes necessary.

These described states according to FIGS. 13 and 14 for the upper tool 11 and for the lower tool 9 are obvious by way of characteristic curves in FIG. 11. The characteristic curve 60 shows a force-distance profile for an upper tool 11 and lower tool 9 without wear, thus with a geometry according to the solid lines in FIG. 12. The characteristic curves 62, 63, 64, 65 located in the area 61 depict the increasing wear at the cutting edge 39 of the upper tool 11, wherein, for example, the characteristic curve 64 with increasing punch travel identifies the increased wear in relation to the characteristic curves 63 or 62. The characteristic curves in the area 66 depict the wear on the lower tool 9, wherein the characteristic curve 67 has, for example, less wear than the further characteristic curves 68, 69 to the right thereof. The characteristic curves 62, 63, 64, 65 for the upper tool 11 are divided, for example, into three classifications. The characteristic curve 62 shows the wear in class 1 with a rounding of 0.25 mm, the characteristic curve 63 shows wear on the upper tool for class 2 with, for example, a rounding of 0.5 mm, etc. This applies similarly to the lower tool 9, wherein the wear rounding is only 0.025 mm in characteristic curve 67 here for the tool of class 1. The characteristic curve 68 shows wear for the lower tool for class 2 with, for example, a rounding of 0.05 mm, etc. The characteristic curve 71 shows the upper tool 11 and the lower tool 9 in which the wear, for example, according to the characteristic curves 62 and 67 is shown superimposed. The characteristic curve 72 shows the superposition of the wear of the upper tool 11 and lower tool 9 according to the characteristic curves 63 and 67. The increasing accompanying wear on the upper tool and/or lower tool 11, 9 can thus in turn be determined separately from one another by a comparison to the characteristic curve 60, which shows the wear-free state of the upper tool and/or lower tool 11, 9, and an evaluation can be made according to the predetermined classification.

Analogous force-distance diagrams according to FIG. 11 can be produced proceeding from the process signals 55, which were determined by the sound sensors 32, for the identification of the material or the plate thickness. For example, the characteristic curves determined therefrom for aluminum, steel, or stainless steel differ from one another.

The following is a summary list of reference numerals and the corresponding structure used in the above description of the invention:
1 machine tool
2 machine frame
3 horizontal frame leg
4 horizontal frame leg
5 vertical frame leg
6 vertical frame leg
7 frame interior
8 workpiece section
9 lower tool
10 workpiece
11 upper tool
12 plunger
13 stroke drive device
14 stroke axis
15 controller
16 upper positioning axis
17 motor drive
18 drive spindle
19 guide rail
20 guide shoe
21 wedge mechanism
22 feed device
23 gripper
24 magazine
25 lower positioning axis
26 motor drive
27 stroke drive device
29 distance sensor
31 force sensor
32 sound sensor
33 acceleration sensor
35 main body
36 chucking pin
37 cutting tool
38 punching surface
39 cutting edge
40 cutting edge with wear
41 main body
42 through hole
44 support surface
46 cutting edge
47 cut surface
49 machining process
50 waiting time
52 process signal
53 process signal
54 process signal
55 process signal
56 process signal
58 characteristic curve
60 characteristic curve of upper tool
61 area
62 characteristic curve
63 characteristic curve
64 characteristic curve
65 characteristic curve of lower tool
66 area
67 characteristic curve
68 characteristic curve
69 characteristic curve
71 characteristic curve
72 characteristic curve

1. A method for monitoring machining processes in a processing machine, the method comprising:
in the machining processes, machining a workpiece with a machining tool that includes an upper tool and a lower tool;
during each machining process, registering time-synchronous process signals by sensors of the processing machine and transmitting the time-synchronous process signals to a control device;
converting the process signals determined as a function of time during the machining processes by a transformation into characteristic curves having a force-distance profile, and recording the force-distance profile independently of time in a force-distance diagram; and
from a profile of the characteristic curves in the force-distance diagram, determining separately from one another at least one of a wear of the machining tool or a material of the workpiece underlying a respective machining process.

2. The method according to claim 1, which comprises eliminating in the control device signal variances of the process signals derived from multiple successive machining processes.

3. The method according to claim 2, wherein to eliminate the signal variances, registering with one or more sensors additional travel components of at least one of the upper tool or the lower tool during the machining process and/or elastic travel components of a machine frame of the processing machine during a stroke movement of at least one of the upper tool or the lower tool.

4. The method according to claim 3, wherein the one or more sensors is at least one sensor selected from the group consisting of a distance sensor and an acceleration sensor.

5. The method according to claim 3, wherein to eliminate the signal variances, registering during repeating machining processes deviations of travel components of at least one of the upper tool or the lower tool as a result of waiting times between the machining processes.

6. The method according to claim 5, which comprises evaluating the registered travel components by a regression function and determining an initial travel of at least one of the upper tool or the lower tool, or depicting the elastic travel components of the machine frame by an analytical model of the machine and tool components.

7. The method according to claim 5, which comprises converting the process signals to be eliminated of the signal variances by transformation independently of time into characteristic curves with the force-distance profile in the force-distance diagram, determining the initial travel from the regression function for a position shift of the upper tool and the lower tool due to a rising process force and a subsequent subtraction or addition of the measured travel of the upper tool and the lower tool and assigned to the force-distance profile of the characteristic curves.

8. The method according to claim 4, wherein, during the machining processes, registering a stroke force by at least one force sensor and a stroke movement of the upper tool and/or lower tool by the at least one distance sensor, and registering travel components of the machine frame as a function of time for the respective machining process by the at least one acceleration sensor, and using the registered signals as a basis for determining the wear of the machining tool by elimination of the signal variances from the process signals and a transformation of the force-distance profile of the characteristic curves.

9. The method according to claim 1, which comprises determining wear states of at least one of the upper tool or the lower tool from a comparison of a reference force-distance profile of characteristic curves of an upper tool and lower tool without wear with the determined force-distance profile of characteristic curves of the respective said upper tool or of characteristic curves of the respective said lower tool from the machining processes.

10. The method according to claim 9, which comprises defining a classification for the wear states for the upper tool and the lower tool separately or jointly and comparing the wear states determined by the characteristic curves to the classification, and wherein a tool change is indicated by the control device if the registered wear state lies outside the permitted classification.

11. The method according to claim 1, which comprises determining wear states of the upper tool and/or lower tool from a comparison of a reference force-distance profile of characteristic curves of an upper tool and lower tool without wear and a superposition of the determined force-distance profile of characteristic curves of the upper tool and lower tool.

12. The method according to claim 1, which comprises registering an acoustic signal during the machining processes by at least one sound sensor and converting the acoustic signal by a Fourier transform into a frequency range, and performing a comparison to reference values on a basis of the amplitudes in the frequency ranges.

13. The method according to claim 1, which comprises, for an upper tool and lower tool which are used for a machining process that contains a severing process in which a workpiece part is cut out of a workpiece, monitoring a cut surface quality from a direct correlation with the wear of the upper tool and the lower tool.

14. A processing machine for machining workpieces, the machine comprising:
an upper tool movably disposed along a stroke axis using a stroke drive device in a direction of a workpiece to be machined with the upper tool and in an opposite direction;
a lower tool which is aligned with the upper tool and which is movable along a lower stroke axis using a stroke drive device in a direction of the upper tool and in an opposite direction;
a control device configured for activating at least one of said upper tool or said lower tool for a stroke movement thereof; and
said control device being configured to carry out the method according to claim 1.

15. The processing machine according to claim 14, wherein the work pieces are metal sheets,

16. The processing machine according to claim 14, which comprises a closed machine frame or a C-shaped machine frame.
